(19) United States
(12) Patent Application Publication
(10) Pub. No.: US 2006/0227382 A1
(43) Pub. Date: Oct. 12, 2006

(54) Method for descreening a scanned image

(75) Inventors: Du-yong Ng, Lexington, KY (US); Khageshwar Thakur, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/095,110

(22) Filed: Mar. 31, 2005

(51) Int. Cl. H04N 1/409

(52) U.S. Cl. 358/3.26; 358/3.08

(57) ABSTRACT

A method for descreening a scanned image includes providing an image in a color space. A target pixel is identified from a plurality of original pixels in the color space. An average value and a standard deviation value is computed for the target pixel with respect to other pixels in a sample window for each channel of the color space. For each channel in the color space an associated lookup table storing a plurality of kernel size values is selected. The average value and the standard deviation value computed for each channel is used to index the associated lookup table to select a kernel size value of the plurality of kernel size values for each channel. The kernel size value for each channel is applied to a low-pass filter to generate filtered pixel values in the color space corresponding to the target pixel, and the target pixel values of the target pixel are replaced with the filtered pixel values.

### BACKGROUND OF THE INVENTION

1. Field of the invention.

The present invention relates to image scanning, and, more particularly, to a method for descreening a scanned image.

2. Description of the related art.

Many documents and images are printed using a variety of halftone screens. When these printed documents and images are scanned using a scanner, artifacts are often present in the scanned images. These artifacts arise from the halftone screens sampled by the sensors of the scanner. If the scanning resolution, i.e., the spatial sampling frequency of the sensors, is sufficiently high (above the Nyquist spatial frequency of those of the halftone screens) to resolve the halftone screens in the hardcopies, then the halftone screens will be present in the scanned images.

As the scanning resolution decreases, aliasing of the halftone screens will occur when the sampling frequency of the scanner sensor is lower than the Nyquist frequency of the halftone screens in the hardcopy. This aliasing gives rise to moire (spatial frequency beating) patterns in the scanned image. The term “artifacts” will be used herein to generally refer to such halftone screens and moire patterns.

A common method to remove the moire and halftone artifacts in scanned images is to scan the hardcopy at a higher resolution followed by a smoothing and downsampling process. This method requires substantially larger storage space for the high-resolution scan and longer scanning duration in order to descreen each scanned image. To avoid performing a higher resolution scan, some methods have been developed to locate the spatial frequencies of the moire and halftone artifacts in a lower resolution scan before notching out these frequency components. This class of methods involves a significant amount of computation to locate and remove the spatial frequency components corresponding to the artifacts. Moreover, these methods are often not very robust in automatically locating the spatial frequency components of interest when the orientation of the halftone screens in the hardcopy is unknown.

### SUMMARY OF THE INVENTION

The present invention provides a method for descreening a scanned image using an approach that is fast and effective in removing artifacts from a low-resolution scan.

The invention, in one exemplary embodiment, is directed to a method for descreening a scanned image, the image being formed by a plurality of original pixels The method includes providing the image in a color space having a channel, each original pixel being represented by an original pixel value in the channel; defining a sample window; identifying a target pixel from the plurality of original pixels in the color space, the target pixel being represented by a target pixel value in the channel; positioning the sample window with respect to the target pixel; computing an average value and a standard deviation value for the target pixel with respect to other pixels in the sample window; selecting for the channel an associated lookup table storing a plurality of kernel size values; using the average value and the standard deviation value computed for the channel to index the associated lookup table to select a kernel size value of the plurality of kernel size values for the channel; applying the kernel size value for the channel to a low-pass filter to generate a filtered pixel value in the color space corresponding to the target pixel; and replacing the target pixel value of the target pixel with the filtered pixel value.

The invention, in another exemplary embodiment, is directed to a method for generating a lookup table for descreening an image generated by a scanner. The method includes scanning a first image at a first resolution to form a training image; scanning the first image at a second resolution, the second resolution being higher than the first resolution, and then down sampling to the first resolution to form a reference image; selecting a color space to be used for processing scanned image data; computing a local average and a standard deviation for each pixel of interest in a given neighborhood; generating a first two-dimensional histogram corresponding to the training image and a second two-dimensional histogram corresponding to the reference image, each of the first two-dimensional histogram and the second two-dimensional histogram having a pixel average axis and a pixel standard deviation axis; determining a line of demarcation in the first two-dimensional histogram based on a visual inspection of differences between the first two-dimensional histogram and the second two-dimensional histogram, wherein a first region on a first side of the line of demarcation is affected by artifacts, and a second region on a second side of the line of demarcation is less affected by artifacts; partitioning the pixel average axis of the first two-dimensional histogram into a first plurality of equally spaced intervals; mapping the first plurality of equally spaced intervals to each row of the lookup table; locating a region of the training image with standard deviation of pixel values on the second side of the line of demarcation for each interval, and assigning a constant to each corresponding entry in the lookup table; subdividing the first region on the first side of the line of demarcation along the pixel standard deviation axis into a second plurality of equally spaced subintervals; locating pixels in each subinterval of the second plurality of equally spaced subintervals; applying a low-pass filter to the pixels in each subinterval and finding the smallest kernel size k* for which artifacts in the pixels in each subinterval are invisible by visual inspection; and assigning k* to a corresponding entry in each corresponding row of the lookup table.

An advantage of the invention over some prior methods is that it does not locate the screen spatial frequency, which may be a very time-consuming process and typically requires a large amount of memory.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a flowchart of a process for building a lookup table to be used in accordance with the present invention.

FIG. 3 is an exemplary two-dimensional histogram for a luminance channel constructed for all the pixels in a training image at 150 dots per inch.

FIG. 4 is an exemplary two-dimensional histogram for a luminance channel constructed for all the pixels in a reference image corresponding to the training image of FIG. 3.

FIG. 5 is a flowchart of the substeps associated with step S110 of FIG. 2.

FIGS. 6A and 6B combine to form a flowchart of a method for descreening a scanned image to remove artifacts from the scanned image in accordance with the present invention.

FIG. 7 is an exemplary printout of an exemplary input image that was scanned at a relatively low resolution, and showing various artifacts prior to applying the method of FIGS. 6A and 6B.

FIG. 8 is an exemplary printout of an output image corresponding to the image of FIG. 7, after application of the method of FIGS. 6A and 6B.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

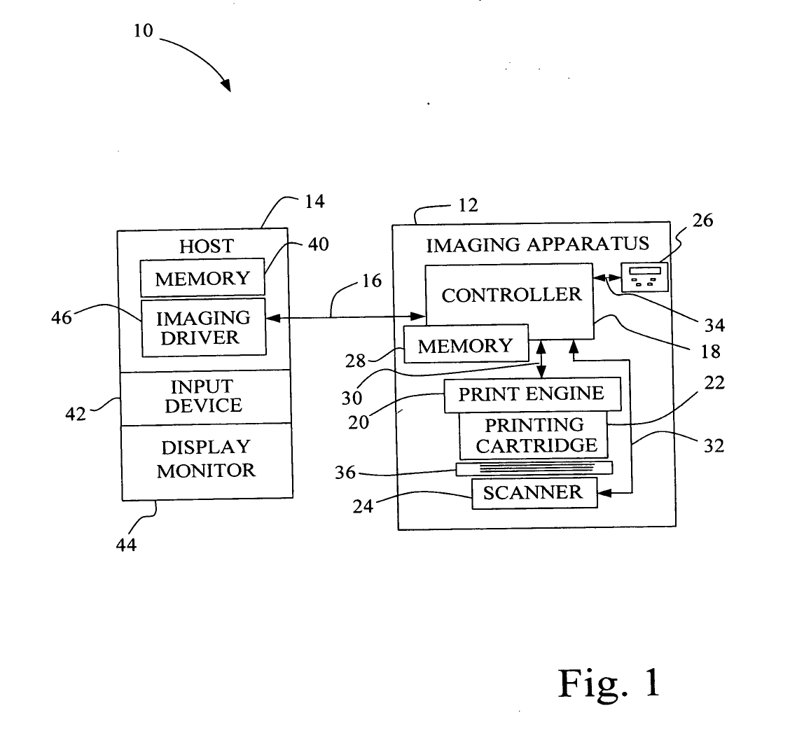

Referring now to the drawings and particularly to FIG. 1, there is shown a diagrammatic depiction of an imaging system 10 embodying the present invention.

Imaging system 10 includes an imaging apparatus 12 and a host 14. Imaging apparatus 12 communicates with host 14 via a communications link 16. As used herein, the term “communications link” is used to generally refer to structure that facilitates electronic communication between two or more components, and may operate using wired or wireless technology.

Imaging apparatus 12 can be, for example, an ink jet printer and/or copier, an electrophotographic printer and/or copier, a thermal transfer printer and/or copier, or an all-in-one (AIO) unit that includes a print engine, a scanner, and possibly a fax unit. An AIO unit is also known in the art as a multifunction device (MFD). For example, as shown in FIG. 1, imaging apparatus 12 includes a controller 18, a print engine 20, a printing cartridge 22, a scanner 24, and a user interface 26. Imaging apparatus 12 may communicate with host 14 via a standard communication protocol, such as for example, universal serial bus (USB) or Ethernet.

Controller 18 includes a processor unit and associated memory 28, and may be formed as one or more Application Specific Integrated Circuits (ASIC). Memory 28 may be, for example, random access memory (RAM), read only memory (ROM), and/or non-volatile RAM (NVRAM). Alternatively, memory 28 may be in the form of a separate electronic memory (e.g., RAM, ROM, and/or NVRAM), a hard drive, a CD or DVD drive, or any memory device convenient for use with controller 18. Controller 18 may be a printer controller, a scanner controller, or may be a combined printer and scanner controller. In the present embodiment, controller 18 communicates with print engine 20 via a communications link 30. Controller 18 communicates with scanner 24 via a communications link 32. User interface 26 is communicatively coupled to controller 18 via a communications link 34. Controller 18 serves to process print data and to operate print engine 20 during printing, as well as to operate scanner 24 and process image data obtained via scanner 24.

In the context of the examples for imaging apparatus 12 given above, print engine 20 can be, for example, an ink jet print engine, an electrophotographic print engine or a thermal transfer engine, configured for forming an image on a substrate 36, such as a sheet of paper, transparency or fabric. As an ink jet print engine, for example, print engine 20 operates printing cartridge 22 to eject ink droplets onto substrate 36 in order to reproduce text and/or images. As an electrophotographic print engine, for example, print engine 20 causes printing cartridge 22 to deposit toner onto substrate 36, which is then fused to substrate 36 by a fuser (not shown), in order to reproduce text and/or images.

Scanner 24 is a conventional scanner, such as for example, a sheet feed or flat bed scanner. As is known in the art, a sheet feed scanner transports a sheet to be scanned past a stationary sensor device. In a flat bed scanner, the sheet or object to be scanned is held stationary, and a scanning bar including a sensor is scanned over the stationary sheet or object. In the context of the present invention, either scanner type may be used. Scanner 24 may scan at various selectable resolutions, such as for example, a low resolution of 150 dots per inch (dpi) and a higher resolution of 600 dpi.

Scanner 24 may include, for example, a CCD (Charge Coupled Device) array. The CCD array is a collection of tiny, light-sensitive diodes, which convert photons into electrons. Many CCD scanners, for example, use a single pass method, wherein the lens splits the image into three smaller versions of the original. Each smaller version passes through a color filter (either red, green or blue) onto a discrete section of the CCD array. The scanner software combines the data from the three parts of the CCD array into a single full-color image. Alternatively, some CCD scan bars use a three pass scanning method, wherein each pass uses a different color filter (red, green or blue) between the lens and CCD array. After the three passes are completed, the scanner software assembles the three filtered images into a single full-color image.

Host 14, which may be optional, may be, for example, a personal computer, including memory 40, such as RAM, ROM, and/or NVRAM, an input device 42, such as a keyboard, and a display monitor 44. Host 14 further includes a processor, input/output (I/O) interfaces, and at least one mass data storage device, such as a hard drive, a CD-ROM and/or a DVD unit.

Host 14 includes in its memory a software program including program instructions that function as an imaging driver 46, e.g., printer/scanner driver software, for imaging apparatus 12. Imaging driver 46 is in communication with controller 18 of imaging apparatus 12 via communications link 16. Imaging driver 46 facilitates communication between imaging apparatus 12 and host 14, and may provide formatted print data to imaging apparatus 12, and more particularly, to print engine 20, to print an image.

In some circumstances, it may be desirable to operate imaging apparatus 12 in a standalone mode. In the standalone mode, imaging apparatus 12 is capable of functioning without host 14. Accordingly, all or a portion of imaging driver 46, or a similar driver, may be located in controller 18 of imaging apparatus 12 so as to accommodate printing during a copying or facsimile job being handled by imaging apparatus 12 when operating in the standalone mode.

In accordance with the present invention, in an image scanned by scanner 24, the variation of pixel values in a local neighborhood defined by an N×N window centered at the pixel of interest can be used to distinguish the region with artifacts from those that are without artifacts. The variation measure includes consideration of an average pixel value with respect to pixel values in a given neighborhood and the standard deviation of the pixel values in this neighborhood. The artifacts exhibit a certain range of variation for a given scanner and this range can be quantified.

The sensitivity of the human visual system to these artifacts varies with the local average of the pixel values. Upon detection, these artifacts may be removed using a low-pass filter. The choice of low-pass filter depends on the strength of the local variation measure and the local average of the pixel values. The average value and standard deviation values will be used to access a lookup table for choosing an appropriate low-pass filter to be used with the pixel of interest.

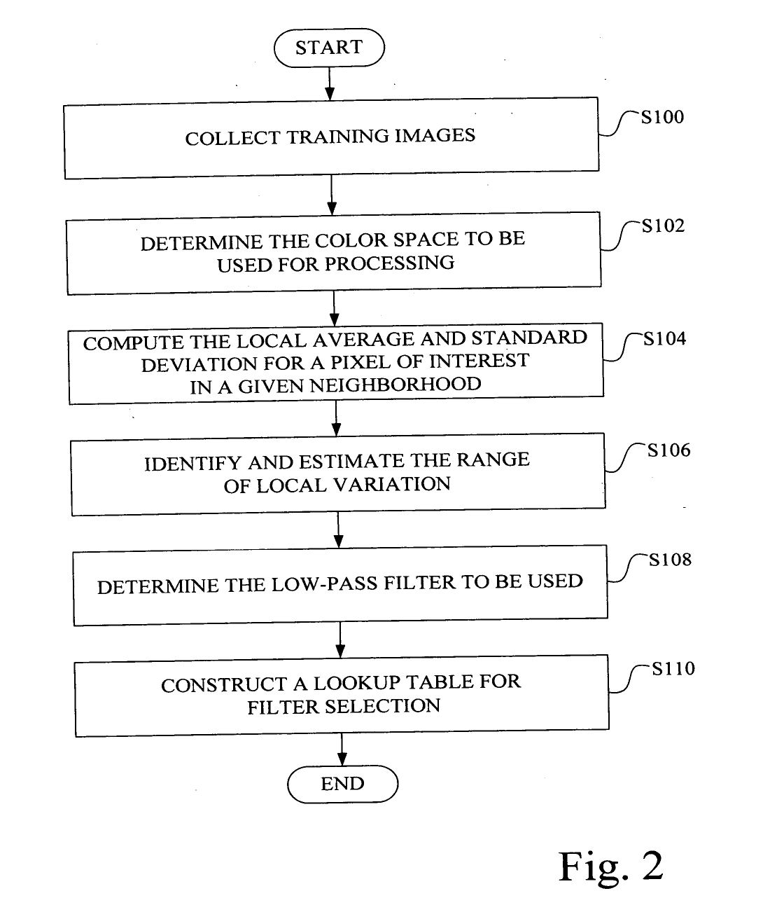

FIG. 2 is a flowchart of a process for building a lookup table to be used in accordance with the present invention, and is described below.

At step S100, training images are collected. The training images may include, for example, magazine images scanned at a relatively low resolution, such as for example, at 150 dots per inch (dpi). A set of training images may contain text, natural scenes, synthetic graphics, people and manmade objects. The same magazine images are also scanned at a higher resolution, such as 600 dpi. These higher resolution scanned images are preprocessed and down sampled to 150 dpi to remove the artifacts, and form a set of reference images corresponding to the training images. The resulting image sets will be used to help construct a lookup table. The scanned images may be sometimes simply referred to as the images.

At step S102, the color space to be used for processing is determined. One color space that may be used to perform descreening using the present invention method is CIE L*a*b* color space, which is a more perceptually uniform color space than, for example, an RGB color space. However, the conversion from the scanner RGB color space to the CIE L*a*b* color space requires significantly more computation than other intermediate color spaces, such as, for example, the Y′CbCr color space. Accordingly, the example that follows will use Y′CbCr color space.

Although the Y′CbCr color space is not perceptually uniform, it relates better to the human visual sensitivity than the scanner RGB color space. The luminance channel, Y′ and the chrominance channels Cb and Cr are weakly correlated. Thus, the sensitivity of human visual system to the artifacts can be studied independently along each channel. The forward and backward transformations from the scanner native RGB color space to the Y′CbCr are given by the Equations 1 and 2 as:

$$\begin{matrix}[ \begin{matrix}{Y}^{′} \\ Cb \\ Cr\end{matrix} ] = [ \begin{matrix}0.2568 & 0.5041 & 0.0979 \\ - 0.1482 & - 0.2910 & 0.4392 \\ 0.4392 & - 0.3678 & - 0.0714\end{matrix} ] \cdot [ \begin{matrix}R \\ G \\ B\end{matrix} ] + [ \begin{matrix}16 \\ 128 \\ 128\end{matrix} ] & ( Equation 1 ) \\ [ \begin{matrix}R \\ G \\ B\end{matrix} ] = [ \begin{matrix}1.1644 & 0 & 1.5960 \\ 1.1644 & - 0.3918 & - 0.8130 \\ 1.1644 & 2.0172 & 0\end{matrix} ] \cdot ( [ \begin{matrix}{Y}^{′} \\ Cb \\ Cr\end{matrix} ] - [ \begin{matrix}16 \\ 128 \\ 128\end{matrix} ] ) & ( Equation 2 )\end{matrix}$$

At step S104, the local average and standard deviation for a pixel of interest in a given neighborhood are computed.

For example, let W_{avg}, a (2m+1)×(2m+1) window, be the neighborhood over which each the pixels are averaged, wherein m is an integer. Then, the local average value for each channel of a pixel at the spatial location (i,j) can be computed by Equations 3, 4 and 5 as:

$$\begin{matrix}{Y}_{I\_avg}^{′} ( i , j ) = \frac{1}{{( 2 m + 1 )}^{2}} \cdot {\sum }_{p = - m}^{m} {\sum }_{q = - m}^{m} {Y}_{I}^{′} ( i + p , j + q ) & ( Equation 3 ) \\ {Cb}_{I\_avg} ( i , j ) = \frac{1}{{( 2 m + 1 )}^{2}} \cdot {\sum }_{p = - m}^{m} {\sum }_{q = - m}^{m} {Cb}_{I} ( i + p , j + q ) & ( Equation 4 ) \\ {Cr}_{I\_avg} ( i , j ) = \frac{1}{{( 2 m + 1 )}^{2}} \cdot {\sum }_{p = - m}^{m} {\sum }_{q = - m}^{m} {Cr}_{I} ( i + p , j + q ) & ( Equation 5 )\end{matrix}$$

The standard deviation for each channel of the pixels in a (2n+1)×(2n+1) window W_{std}, wherein n is an integer, is given by Equations 6, 7 and 8 as:

$$\begin{matrix}{Y}_{I\_std}^{′} ( i , j ) = \sqrt{\frac{1}{{( 2 n + 1 )}^{2} - 1} \cdot {\sum }_{p = - n}^{n} {\sum }_{q = - n}^{n} {( {Y}_{I}^{′} ( i + p , j + q ) - {Y}_{I\_avg}^{′} ( i , j ) )}^{2}} & ( Equation 6 ) \\ {Cb}_{I\_std} ( i , j ) = \sqrt{\frac{1}{{( 2 n + 1 )}^{2} - 1} \cdot {\sum }_{p = - n}^{n} {\sum }_{q = - n}^{n} {( {Cb}_{I} ( i + p , j + q ) - {Cb}_{I\_avg} ( i , j ) )}^{2}} & ( Equation 7 ) \\ {Cr}_{I\_std} ( i , j ) = \sqrt{\frac{1}{{( 2 n + 1 )}^{2} - 1} \cdot {\sum }_{p = - n}^{n} {\sum }_{q = - n}^{n} {( {Cr}_{I} ( i + p , j + q ) - {Cr}_{I\_avg} ( i , j ) )}^{2}} & ( Equation 8 )\end{matrix}$$

Equations 6, 7 and 8 are the same as the conventional definition of standard deviation if window W_{avg} and window W_{std} have the same size. However, it has been observed that artifacts may be identified more accurately when window W_{avg} is greater in size than window W_{std}. Statistically, a larger window W_{avg} produces a more representative local average. However, variation of pixel values in a smaller window W_{std} tends to identify the artifacts better. Despite using a different window size, this variation will be referred to as the standard deviation.

The size of the neighborhood, i.e., window, depends on the scanning resolution. For a 150 dpi scan resolution, for example, it has been determined that values of m=2 and n=1 give a good trade off between speed and performance.

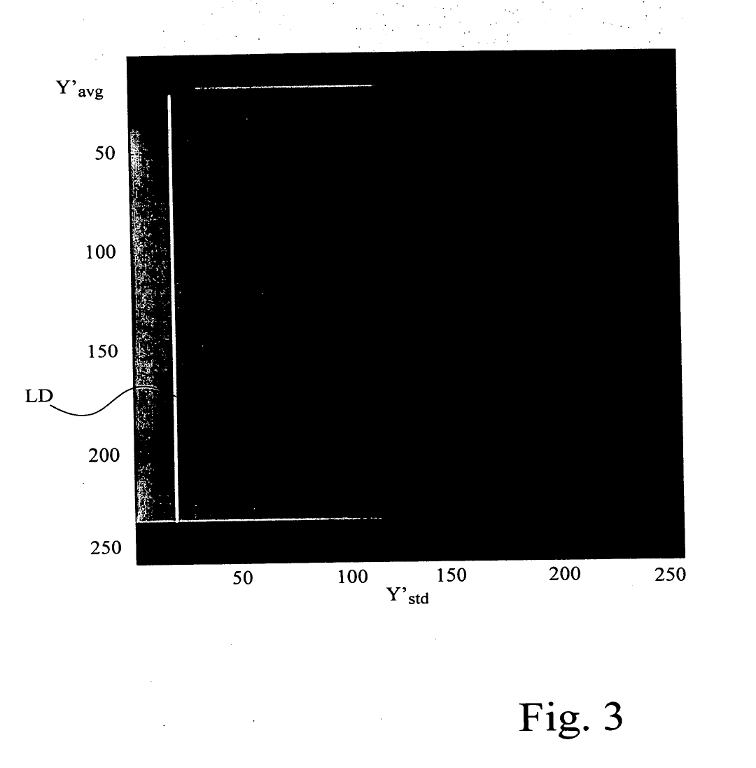

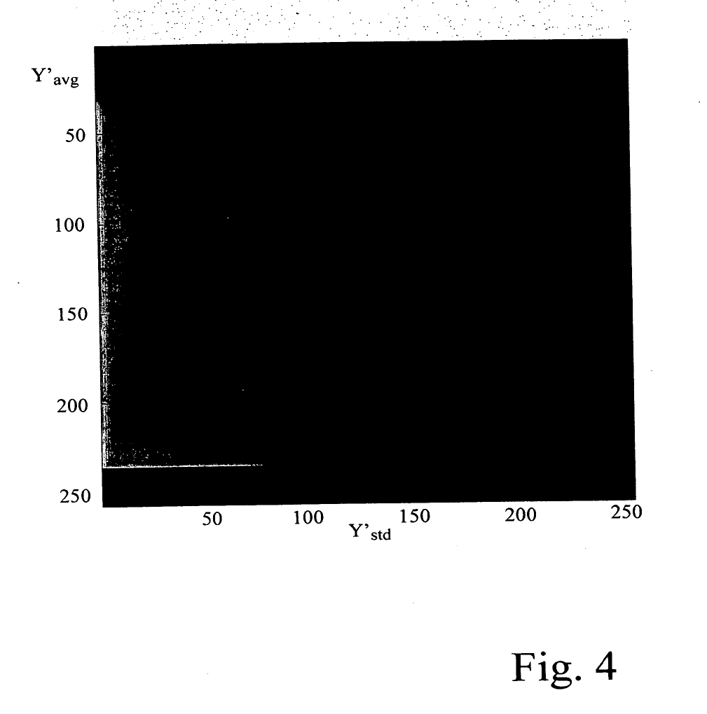

At step S106, the method identifies and estimates the range of local variation. To identify the range of pixel value variation that corresponds to the artifacts, the training images and the reference images are first converted to Y′CbCr data. The luminance values Y′₁_{_{—}}_{avg} and Y′₁_{_{—}}_{std} are computed for every pixel in both the training image set and reference image set. A two-dimensional histogram having a pixel average axis, e.g., Y′₁_{_{—}}_{avg}, and having a pixel standard deviation axis, e.g., Y′₁_{_{—}}_{std}, is constructed for all the pixels in the training image set. The results are shown in FIG. 3. This is repeated for the pixels in the reference image set, and the results are shown in FIG. 4. Each of the two-dimensional histograms has 255×255 bins. The number of pixels in each bin is plotted as the intensity. Brighter regions in FIGS. 3 and 4 correspond to bins with larger number of pixels from the images. FIG. 3 indicates that the training images are not as smooth as the reference images.

A location of a line of demarcation LD inserted in the two-dimensional histogram of FIG. 3 is determined based on a visual inspection of differences between the two-dimensional histogram of FIG. 3 and the two-dimensional histogram of FIG. 4. There are relatively fewer pixels with a standard deviation less than 5 in the training images resulting in the histogram of FIG. 3 compared to the reference images resulting in the histogram of FIG. 4. Since the artifacts are present for a substantial portion of the training images, the brightest region, i.e., the region to the left of the line of demarcation LD in FIG. 3 corresponds to the pixels affected by the artifacts. This is the region that filtering will be performed on the pixels to remove the artifacts. These procedures are repeated for channels Cb and Cr.

At step S108, the low-pass filter to be used is determined. A low-pass filter smoothes the texture, removes high frequency noise and destroys moire patterns and halftone screens, i.e., artifacts, in an image. Although the range of variation corresponding to the artifacts in FIG. 3 appears to be consistent along the pixel average axis, e.g., Y′₁_{_{—}}_{avg}, the human visual system sensitivity to the artifacts varies along this axis. The goal is to smooth the artifacts to the level that is no longer visible to the human observer and keep as much details as possible. So, it is necessary to apply different levels of smoothing operation according to human visual sensitivity.

In the present embodiment, a separable Gaussian low-pass filter is chosen. A discrete space, two-dimensional circular symmetric and separable Gaussian filter with kernel size k×k is given by Equation 9 as:

$${f}_{k} ( p , q ) = \{ \begin{matrix}\frac{{ⅇ}^{\frac{1}{2 {σ}^{2}} ( {p}^{2} + {q}^{2} )}}{{\sum }_{( p , q ) ∈ {W}_{k}} {ⅇ}^{\frac{1}{2 {σ}^{2}} ( {p}^{2} + {q}^{2} )}} , & ( p , q ) ∈ {W}_{k} \\ 0 , & otherwise\end{matrix} \qquad ( Equation 9 )$$

where Wₖ is a k×k window and σ is the standard deviation of the Gaussian filter. By experimentation, it was determined that k∈{1, 3, 5, 7, 9} with σ=0.6 is sufficient to remove the artifacts. When k=1, f₁(p,q)=δ(p,q). In this case, the original pixel value is kept.

At step S110, a lookup table for filter selection is constructed. The lookup table varies with the type of filters, the sizes of the filter kernel and the characteristic of the scanner.

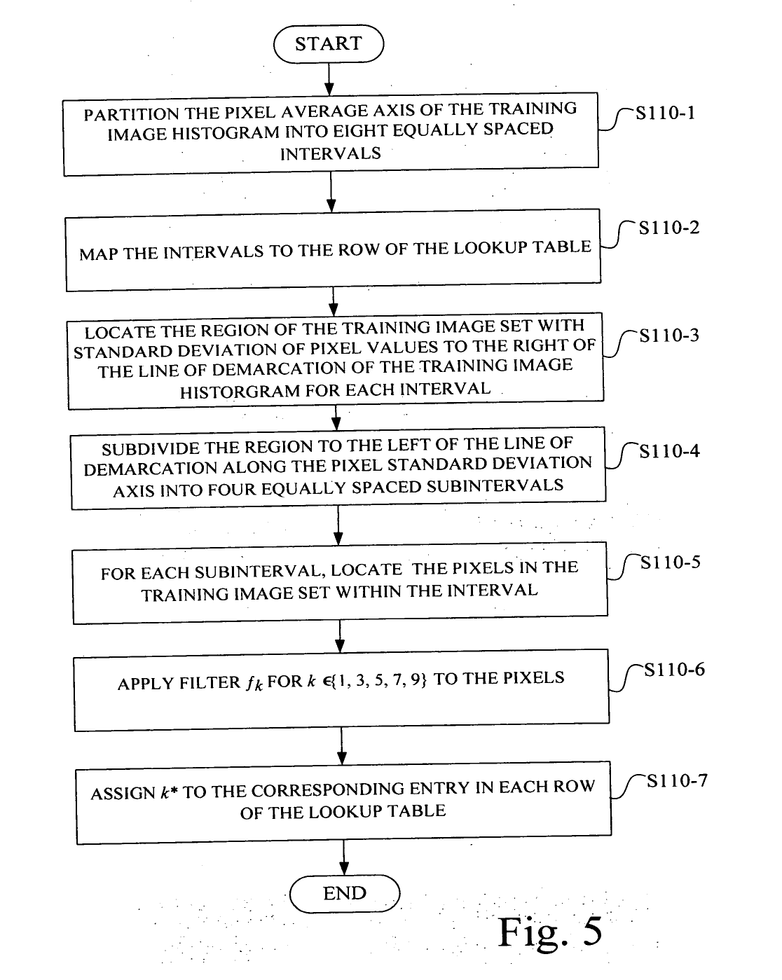

FIG. 5 shows a flowchart of the substeps associated with step S110 of FIG. 4 for construction of an exemplary lookup table.

At step S110-1, the pixel average axis, e.g., Y′₁_{_{—}}_{avg}, of the training image histogram of FIG. 3 is partitioned into eight equally spaced intervals.

At step S110-2, the intervals are mapped to the rows of the lookup table.

At step S110-3, the region of the training image set is located with standard deviation of pixel values to the right of the line of demarcation LD in FIG. 3 for each interval. For this region, the original pixel is used, i.e., use filter f₁ for these pixels, and assign unity, i.e., 1, to the corresponding entries of the table.

At step S110-4, the region to the left of line of demarcation LD along the pixel standard deviation axis, e.g., is subdivided into 4 equally spaced subintervals.

At step S110-5, for each subinterval, the pixels in the training image set within this interval are located.

At step S110-6, filter fₖ for size of the kernal k∈{1, 3, 5, 7, 9} is applied to the pixels located in step S110-5 and the smallest k value, denoted as k*, is found for which the artifacts in these pixels are completely invisible by visual inspection.

At step S110-7, k* is assigned to the corresponding entry in each row of the lookup table.

Each interval can be subdivided repeatedly to achieve better results if it is necessary. Steps S110-1 through S110-7 are repeated for channels Cb and Cr. Generally, the size of the table for channels Cb and Cr is smaller than that for the channel Y′. The human visual system has a higher sensitivity in luminance channel Y′ compared to the chrominance channels Cb and Cr, and all three channels are not completely orthogonal to one another. To preserve edges in channel Cb and Cr while removing the artifacts, it may be desirable to fine-tune the table for channel Y′ using the following formula:
Table_{Y′}(x,y)=min(Table_{Y′}(x,y), Table_{Cb}(x,y), Table_{Cr}(x,y))

where x and y are the row and column of the table.

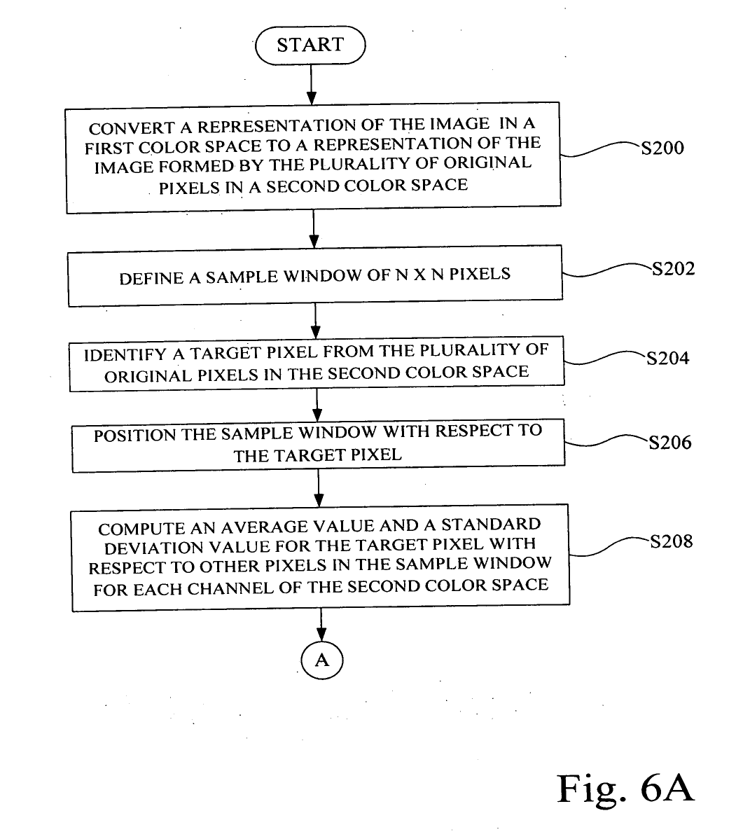

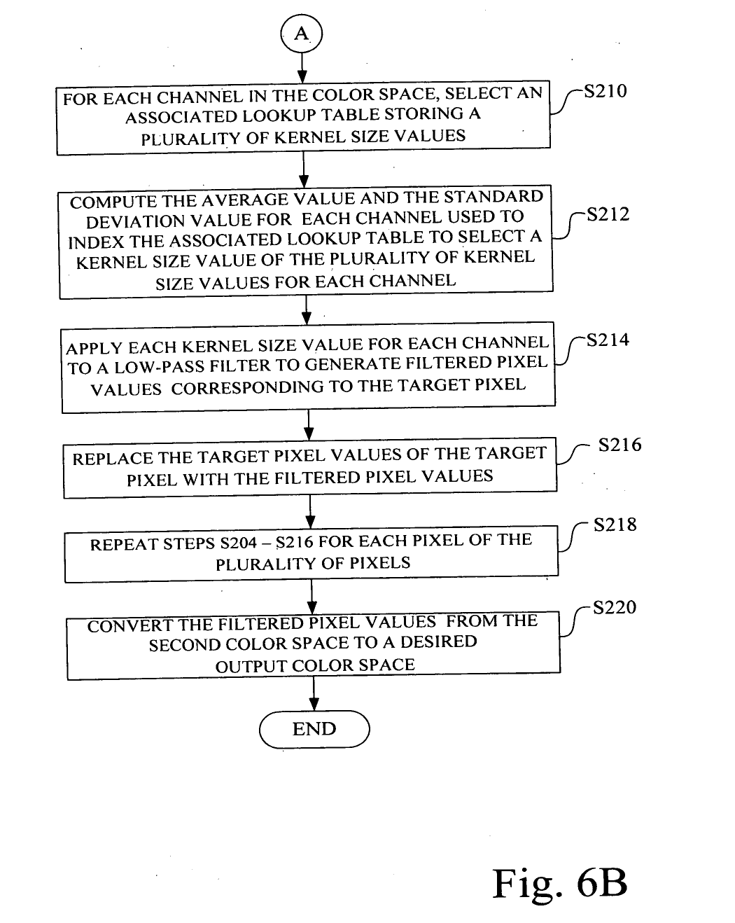

FIGS. 6A and 6B combine to form a flowchart of a method for descreening a scanned image to remove artifacts from a scanned image formed by a plurality of original pixels, in accordance with the present invention, using the lookup tables generated above. The scanned image will be scanned at a relatively low resolution, such as for example, 150 dots per inch. FIG. 7 is a printout of an exemplary input image that was scanned at 150 dpi, and shows various artifacts prior to applying the method of FIGS. 6A and 6B. The low-resolution scanned image then may be descreened in accordance with the present invention to produce a high quality image at a click of a button from user interface 26 of imaging apparatus 12, or from input device 42 of host 14, using the method described below. The method may be implemented in software and/or firmware residing and executing, in whole or in part, in imaging apparatus 12 and/or host 14.

At step S200, a representation of the image I formed by a plurality of original pixels in a first color space, such as for example, RGB, is converted to a representation of the image formed by the plurality of original pixels in a second color space, such as for example Y′CbCr, for the plurality of original pixels. The Y′CbCr color space has a luminance channel Y′ and two chrominance channels Cb and Cr. Each original pixel in the color space Y′CbCr is represented by an original pixel value in each of the channels Y′, Cb, and Cr. This conversion may be performed, for example, using Equation 1, described above.

Alternatively, if the image data is already provided in the desired color space, such as Y′CbCr color space, then no conversion of the image data is necessary.

At step S202, a sample window of N×N pixels is defined, wherein N is a positive integer. Preferably, N is a positive odd integer greater than 2.

At step S204, a target pixel is identified from the plurality of original pixels in the Y′CbCr color space. The target pixel, as an original pixel in the Y′CbCr color space, is accordingly represented by a plurality of target pixel values including a target pixel value in each channel of the plurality of channels Y′, Cb and Cr.

At step S206, the sample window is positioned with respect to the target pixel. The sample window may be centered at the target pixel of interest.

At step 208, an average value and a standard deviation value for the target pixel is computed with respect to other pixels in the sample window for each channel of the Y′CbCr color space. For example, for each pixel of image I at spatial location (i, j), compute Y′₁_{_{—}}_{avg}, Y′₁_{_{—}}_{std, Cb′}₁_{_{—}}_{avg}, Cb′₁_{_{—}}_{std}, Cr′₁_{_{—}}_{avg} and Cr′₁_{_{—}}_{std} using Equations 3-8, described above.

At step 210, for each channel in the color space, an associated lookup table storing a plurality of kernel size values is selected.

At step S212, the average value and the standard deviation value computed for the each channel is used to index the associated lookup table to select a kernel size value of the plurality of kernel size values for each channel. In other words, for each channel, the corresponding lookup table is used to determine the appropriate filter and apply it to I(i, j).

At step S214, each kernel size value for each channel is applied to a low-pass filter to generate filtered pixel values corresponding to the target pixel. One exemplary low-pass filter is set forth above in Equation 9. By using a set of circular symmetric low-pass filters, for example, the present method works well for screens of any orientation.

At step S216, the target pixel values of the target pixel are replaced with the filtered pixel values. In other words, each filtered pixel value is assigned to the output image O pixel at location (i, j).

At step S218, steps S204-S216 are repeated for each pixel of the plurality of original pixels in the Y′CbCr color space.

At step S220, the filtered pixel values are converted from the Y′CbCr color space to a desired output color space, such as RGB color space, and the filtered RGB data may then be used in generating a final output image using imaging apparatus 12, or the data may be saved to memory. The conversion of output image O back to an RGB output image may be performed using Equation 2, described above.

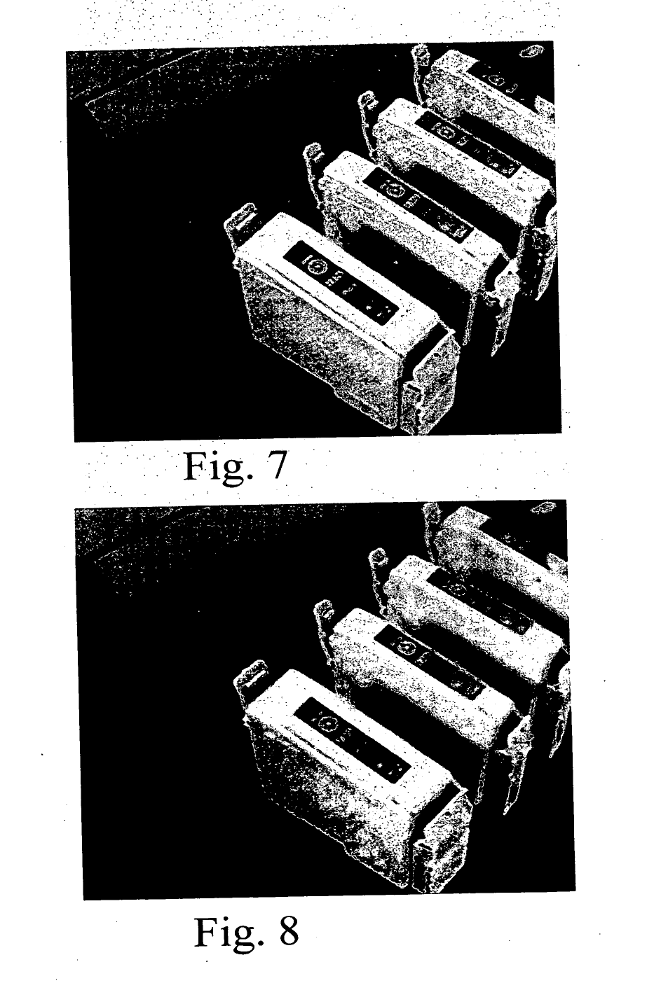

FIG. 8 shows a printout of an output image corresponding to the image of FIG. 7, after application of the method of the present invention. In comparing FIG. 7 with FIG. 8, it is shown that a significant image quality improvement is realized by a reduction or elimination of artifacts, e.g., halftone screens, in accordance with the present invention.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for descreening a scanned image, said image being formed by a plurality of original pixels, including:
(a) providing said image in a color space having a channel, each original pixel being represented by an original pixel value in said channel;
(b) defining a sample window;
(c) identifying a target pixel from said plurality of original pixels in said color space, said target pixel being represented by a target pixel value in said channel;
(d) positioning said sample window with respect to said target pixel;
(e) computing an average value and a standard deviation value for said target pixel with respect to other pixels in said sample window;
(f) selecting for said channel an associated lookup table storing a plurality of kernel size values;
(g) using said average value and said standard deviation value computed for said channel to index said associated lookup table to select a kernel size value of said plurality of kernel size values for said channel;
(h) applying said kernel size value for said channel to a low-pass filter to generate a filtered pixel value in said color space corresponding to said target pixel; and
(i) replacing said target pixel value of said target pixel with said filtered pixel value.

2. The method of claim 1, further comprising repeating steps (c) through (i) for each pixel of said plurality of original pixels, and wherein a new target pixel is selected for each repetition.

3. The method of claim 2, further comprising repeating steps (c) through (i) for each channel of a plurality of channels in said color space.

4. The method of claim 1, wherein said color space is an intermediate color space to which said image in a native color space from a scanner was converted.

5. The method of claim 4, wherein said native color space is an RGB color space and said intermediate color space is Y′CbCr color space.

6. The method of claim 1, wherein said sample window is centered at said target pixel.

7. The method of claim 1, wherein said plurality of kernel size values vary in accordance with the sensitivity of the human eye.

8. The method of claim 1, further comprising:
(j) converting said filtered pixel value from said color space to an output color space.

9. The method of claim 8, wherein said output color space is an RGB color space.

10. The method of claim 8, further comprising repeating steps (c) through (i) for each pixel of said plurality of original pixels in said color space prior to converting to said output color space.

11. The method of claim 1, wherein said sample window is N×N pixels, and wherein N is a positive integer.

12. The method of claim 11, wherein N is a positive odd integer greater than 2.

13. A method for generating a lookup table for descreening an image generated by a scanner, including:
(a) scanning a first image at a first resolution to form a training image;
(b) scanning said first image at a second resolution, said second resolution being higher than said first resolution, and then down sampling to said first resolution to form a reference image;
(c) selecting a color space to be used for processing scanned image data;
(d) computing a local average and a standard deviation for each pixel of interest in a given neighborhood;
(e) generating a first two-dimensional histogram corresponding to said training image and a second two-dimensional histogram corresponding to said reference image, each of said first two-dimensional histogram and said second two-dimensional histogram having a pixel average axis and a pixel standard deviation axis;
(f) determining a line of demarcation in said first two-dimensional histogram based on a visual inspection of differences between said first two-dimensional histogram and said second two-dimensional histogram, wherein a first region on a first side of said line of demarcation is affected by artifacts, and a second region on a second side of said line of demarcation is less affected by artifacts;
(g) partitioning the pixel average axis of said first two-dimensional histogram into a first plurality of equally spaced intervals;
(h) mapping said first plurality of equally spaced intervals to each row of said lookup table;
(i) locating a region of said training image with standard deviation of pixel values on said second side of said line of demarcation for each said interval, and assigning a constant to each corresponding entry in said lookup table;
(j) subdividing said first region on said first side of said line of demarcation along said pixel standard deviation axis into a second plurality of equally spaced subintervals;
(k) locating pixels in each subinterval of said second plurality of equally spaced subintervals;
(l) applying a low-pass filter to said pixels in each subinterval and finding a smallest kernel size k* for which artifacts in said pixels in each subinterval are invisible by visual inspection; and
(m) assigning k* to a corresponding entry in each corresponding row of said lookup table.

14. The method of claim 13, comprising repeating steps (c) through (m) for each channel of said color space.

15. The method of claim 13, wherein said color space is Y′CbCr color space.

16. The method of claim 13, wherein said low-pass filter is a Gaussian filter.

17. The method of claim 13, wherein said constant is one.
